(19) United States
(12) Patent Application Publication
(10) Pub. No.: US 2005/0080911 A1
(43) Pub. Date: Apr. 14, 2005

(54) System and method for the packaging and distribution of data

(76) Inventors: Todd A. Stiers, Berkeley, CA (US); Jeremy S. de Bonet, North Andover, MA (US); Phillip Alvelda VII, Oakland, CA (US); Jeffrey R. Annison, Clayton, CA (US)

Correspondence Address: SPRINKLE IP LAW GROUP, 1301 W. 25TH STREET, SUITE 408, AUSTIN, TX, 78705, US

(21) Appl. No.: 10/664,246

(22) Filed: Sep. 17, 2003

Related U.S. Application Data
(60) Provisional application No. 60/411,518, filed on Sep. 17, 2002.

(51) Int. Cl. G06F 15/16

(52) U.S. Cl. 709/230

(57) ABSTRACT

Systems and methods are described which allow data to be packaged and optimized for distribution to a certain device. These systems and methods may include separating incoming data into portions, and converting each of these portions into multiple formats. Each of these portions can then be encapsulated in a packet corresponding to one portion of the data represented in one format. A packet may then be selected for delivery to a device based upon the characteristics of that device at any particular moment. In this manner, the delivery of the data may be customized according to many different criterion without impeding the delivery or usage of that data.

### RELATED APPLICATIONS

This application claims a benefit of priority under 35 U.S.C. § 119(e) to U.S. Patent Application No. 60/411,518 entitled “Media Network Bridge System and Method for Redistribution, Re-Purposing, Optimization, Management, Streaming Data and Content Across Networks” by Stiers et al., filed Sep. 17, 2002. This application is related to U.S. patent application Ser. No. 10/360,172, entitled “Plug-In API for Modular Network Transaction Processing” by DeBonet et al., filed on Feb. 7, 2003; Ser. No. 10/360,952, entitled “Plug-In API for Protocol and Payload Transformation” by DeBonet et al., filed on Feb. 7, 2003; 60/431,653, entitled “Device for the Conversion Between Application-Level Network Protocols” by DeBonet et al., filed on Dec. 6, 2002; 60/427,651, entitled “System and Method for the Dynamic Combination of Plug-In Software Modules” by DeBonet et al., filed on Nov. 19, 2002; Ser. No. 10/345,084, entitled “System and Method for Program Configuration” by DeBonet et al., filed on Jan. 15, 2003; Ser. No. 10/342,113, entitled “Method and System of Performing Transactions Using Shared Resources and Different Applications” by Alvelda et al., filed on Jan. 14, 2003; Ser. No. 10/345,593, entitled “A Design for Storage and Retrieval of Arbitrary Content and Application Data” by Alvelda et al., filed on Jan. 16, 2003; Ser. No. 10/345,880, entitled “A Highly-Redundant, High-Reliability and High-Performance Platform Logging/Billing Generation and Collection Subsystem” by DeBonet et al., filed on Jan. 16, 2003; and 60/349,344, entitled “A Modular Plug-In Transaction Processing Archtiecture” by Alvelda et al., filed on Jan. 18, 2002. All applications cited within this paragraph are assigned to the current assignee hereof and are fully incorporated herein by reference.

### TECHNICAL FIELD OF THE INVENTION

This invention relates generally to content delivery systems, and more particularly, to the packaging and distribution of content to widely disparate networks and devices.

### BACKGROUND OF THE INVENTION

Over the past few years there has been a marked proliferation of personalized communication devices such as mobile phones, laptop computers, and personal digital assistants (PDAs). The popularity of these devices with the general populous is based in no small part on their ability to access a wide variety of information, regardless of location, by virtue of wireless communication.

Consequently, wireless communication systems are utilized to provide an ever growing portion of the communications capacity currently available to users, despite the additional technological impediments faced in implementing a wireless communication system, as compared to a wireline system. Though a whole host of issues crops up in wireless communication systems, many of these relate to the relaying and enhancing of audio and video content between heterogeneous networks and devices.

These issues, however, have in no way decreased the user's of these devices thirst for ever more complex data, including internet content, video or television broadcast data, music, and other streaming media. In fact, as high-bandwidth devices and networks become more widely utilized the demand for this type of data has increased markedly. Typically, this data could only be disseminated over a high-bandwidth connection to devices capable of displaying this type of information.

This solution is problematic, users on low bandwidth networks, and with inferior personal devices, still desire this type of data. In order to deliver this type of data over all types of networks, the data may be sampled and optimized for delivery over a network with a certain set of capabilities. This is also a non optimum solution, high bandwidth networks and devices experiences outages and reductions in transmission rates. Furthermore, a wireless device in one area may have a certain bandwidth while another device may have a much lower bandwidth (e.g. in a tunnel, or area of low reception), and the bandwidth of each device on a network may vary dynamically.

Thus, there is a need for systems and methods which can dynamically package and distribute complex content to a wide variety of networks and devices.

### SUMMARY OF THE INVENTION

Systems and methods for the packaging and distribution of data are disclosed. These systems and methods allow transmissions of data to be tailored to individual devices, their capabilities, and their user's desires. In many embodiments, data to be delivered to a device may be separated into portions and these portions converted into a variety of formats, these converted portions are then encapsulated in such a manner that a packet contains one portion of the data represented in one format. A packet containing a particular portion of the data in a particular format can then be selected for delivery to a device based on a set of criteria.

Additionally, systems are presented which embody this type of methodology in computer systems, hardware, and software that package and distribute data to devices.

Systems are also presented which act as a media bridge between streaming data and a wireless network.

In one embodiment, the data is digitized.

In some embodiments, the data is augmented when it is converted to different formats.

In other embodiments, the set of criteria is updated.

In yet other embodiments, the selected packet is delivered to the device.

Still other embodiments evaluate the set of criteria when selecting a packet for delivery to the device.

In another set of embodiments, a set of rules is used to evaluate the set of criteria.

These, and other, aspects of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein identical reference numerals designate the same components. The invention may be better understood by reference to one or more of these drawings in combination with the description presented herein. It should be noted that the features illustrated in the drawings are not necessarily drawn to scale.

FIG. 1 is a block diagram of an exemplary system for use with embodiments of the present invention.

FIG. 2 is a flow diagram of an embodiment of the present invention.

FIG. 3 is a depiction of an embodiment of converting portions of data, encapsulating these portions in packets and selecting packets to be delivered to a device; and

FIG. 4 is a more detailed depiction of an embodiment of selecting packets to be delivered to a device.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

A few terms are defined or clarified to aid in understanding the descriptions that follow: a device may be any sort of apparatus which can receive and display data including mobile phones, PDAs, laptop computers and the like.

A format is a way of arranging, organizing, or representing data, usually using a defined standard such as MPEG or motion JPEG. For purposes of this application formats will be understood to be distinct if characteristics of the represented data differ in any manner, additionally the same standard at two different rates will be understood to mean two distinct formats. For example, high framerate motion JPEG would be a distinct format from low framerate motion JPEG. Furthermore, augmenting a defined standard with additional information will be understood to constitute a distinct format. For example, augmenting an MPEG representation of video data with closed captioning information would be a distinct format from video data represented in the MPEG format alone. Compressed video data will also be understood as distinct from its uncompressed equivalent. For example, video data compressed with MPEG will be understood as distinct format from identical uncompressed raw video data. It will be obvious to those of ordinary skill in the art that for purposes of this application distinct formats may be created in an almost endless variety of ways, such as varying resolution, screen size, sampling rate, and the like.

Though the exemplary embodiment described below utilizes embodiments of the present invention in a media bridge designed to convert broadcast media such as television into a variety of formats for delivery over a wireless communication network, those skilled in the art will appreciate that these same systems and methods may be employed for a myriad number of other uses and applications, such as delivering internet content over a wireline system, or other type of network topology. Additionally, it will be understood that these same systems and methods, or any subset, can be implemented in software systems, computer programs, hardware, and any combination thereof.

Attention is now directed to systems and methods for packaging and distributing content. These systems and methods may divide content into portions and convert these portions into a variety of different formats. This data may then be encapsulated in packets, with one packet containing one portion of the data in one particular format. Based on certain criteria, a packet may be selected and delivered to the device. The systems and methods described herein may be especially useful at dynamically customizing data delivered to a particular device.

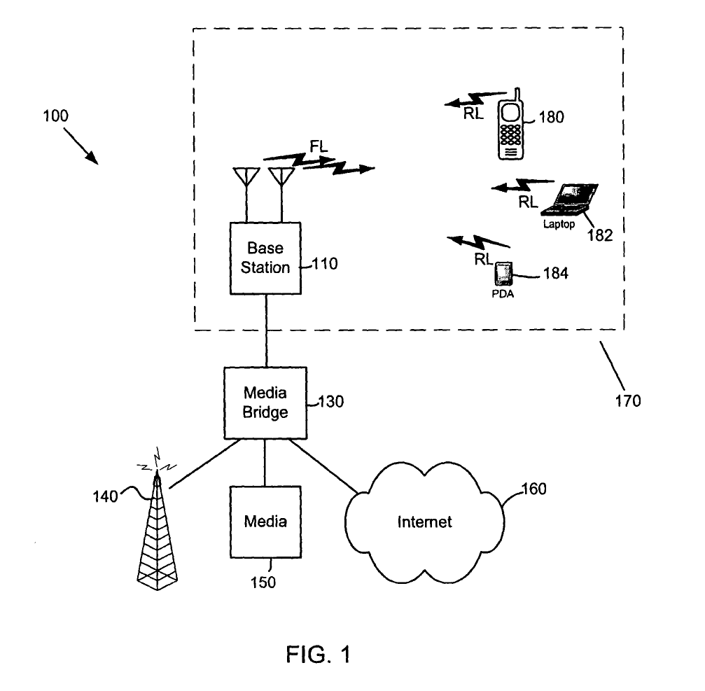

Turning now to FIG. 1, a diagram illustrating the structure of an exemplary communications system for utilization with embodiments of the present invention is shown. As depicted in this figure, this system 100 comprises a media bridge 130 for interfacing between different types of content systems 140, 150, 160 and one or more wireless (or potentially wireline) communication networks 170. Content systems 140, 150, 160 may be broadcast media such as television or radio, other audio or video data, such as a video feed from a DVD player, or the Internet.

Wireless communication network 170 is in turn composed of base station 110 that is configured to communicate with a plurality of mobile devices (devices) 180, 182, 184. Mobile devices 180, 182, 184 may, for example, be cellular telephones, laptop computers, personal information managers (PIMs or PDA), or the like that are configured for wireless communication. These devices 180, 182, 184 may be running software designed for use with embodiments of the present invention. It should be noted that these devices 180, 182, 184 need not actually be “mobile,” but may simply communicate with base station 110 via a wireline or wireless link. Base station 110 transmits data to mobile devices 180, 182, 184 via corresponding forward link (FL) channels, while mobile devices 180, 182, 184 transmit data to base station 110 via corresponding reverse link (RL) channels.

Users of mobile devices 180, 182, 184 may wish to have content from content sources 140, 150, 160 delivered to them. This may be problematic, however, as delivery of much of this content typically requires large amounts of data to be delivered over a high-reliability high-bandwidth connection. Additionally, even if wireless network 170 is such a high-bandwidth network, mobile devices 180, 182, 184 may experience temporary periods of low-bandwidth connection to base station 110, or may be incapable of handling the complexity of such content. Media bridge 130 alleviates these problems by delivering tailored content from content source 140, 150, 160 to each individual mobile device 180, 182, 184.

Media bridge 130 may employ embodiments of the present invention to allow content from content sources 140, 150, 160 to be delivered to mobile devices 180, 182, 184 based upon a set of criteria associated with these mobile devices 180, 182, 184. Streaming content from a content source 140, 150, 160 is fed into media bridge 130, at which point media bridge 130 may capture and digitize the incoming content if the data is not already in a digital format. This digitized data may be divided up into portions and converted to a wide variety of formats. This data can then be encapsulated in packets and a particular series of packets may be sent to base station 110 for delivery to mobile device 180 depending on criteria associated with that particular device 180. It should be noted that the mobile devices 180, 182, 184 and system components in this figure are exemplary and other systems may comprise other types and other combinations of devices.

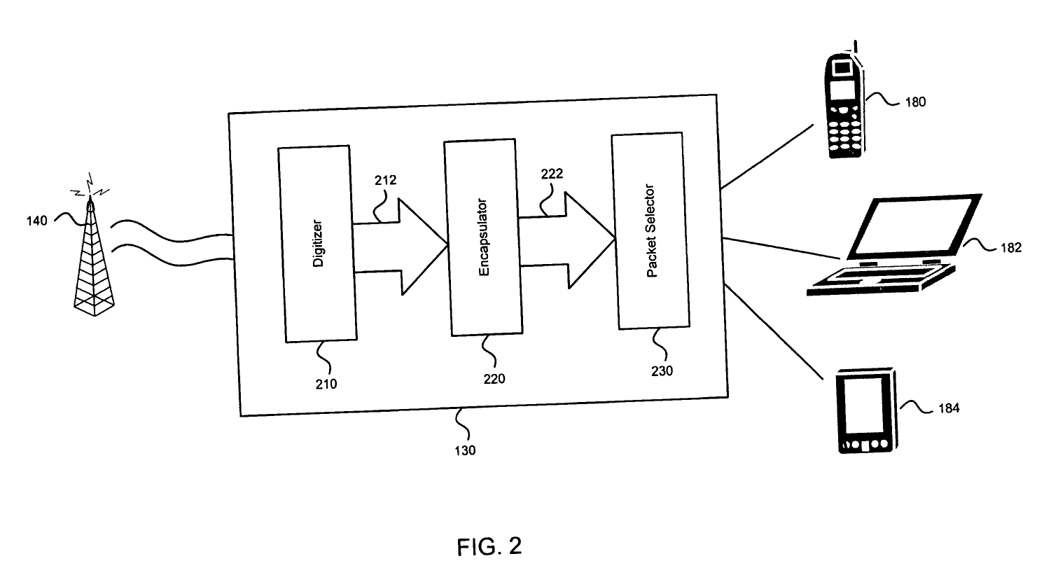

Embodiments of the present invention which may be employed by media bridge 130 are depicted in more detail in FIG. 2. Content coming from media source 140 which is to be delivered to a device 180 may be in an analog format. This analog content, such as a television signal, radio broadcasts or video game data, may be captured using automatic or manual capture methods, and converted to a digital signal (STEP 210). One of ordinary skill in the art will understand the many and varied ways to accomplish this capture and analog to digital conversion (STEP 210). In one embodiment, raw TV signal 140 may be connected to a TV tuner capture card, which in turn captures incoming analog TV signal 140. This analog signal 140 may be converted to a digital signal via the use of a standard analog to digital converter of the type that are well known in the art.

The resulting digital data 212 may be converted to a variety of formats and encapsulated in packets (STEP 220) in order to facilitate delivery of data 212 to device 180. Packets of this data 222 may then be selected for delivery (STEP 230) to device 180 based upon a set of criteria.

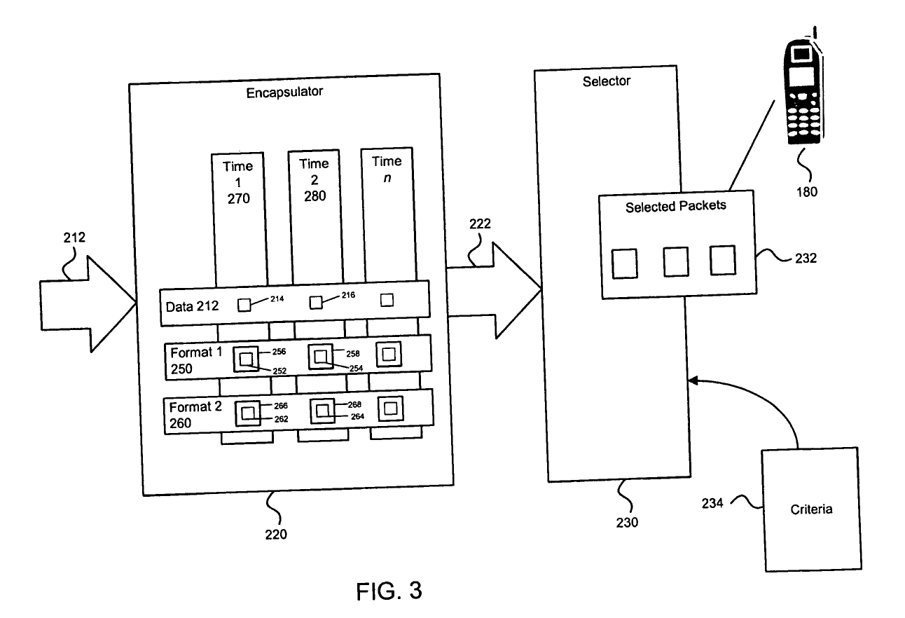

Moving now to FIG. 3, embodiments of the process for encapsulating data (STEP 220) are depicted in greater detail. Encapsulation process (STEP 220) may in turn include separating original data 212 into portions 214, 216 and converting those portions 214, 216 into a variety of different formats 250, 260. The resulting portions 252, 254, 262, 264 of data in different formats 250, 260 cover time periods 270, 280 corresponding to portions 214, 216 of original data 212. In other words, a portion 252 of data in one format 250 covers the same time period 270 of original data 212 as corresponding portion 262 in another format 260.

To elucidate more clearly, if incoming original data 212 is digitized video data, original data 212 may be divided into portions 214, 216 which cover the first 20 seconds of the video represented by original data 212, with one portion 214 representing the first 10 seconds (time period one 270) and another portion 216 representing the second 10 seconds (time period two 280). Portions 214, 216 may then be converted to two different formats 250, 260. The resulting data portions 252, 262 corresponding to original portion 214 represent the same first 10 seconds (time period one 270) of original data 212, albeit in two different formats 250, 260. Similarly, data portions 254, 264 corresponding to original data portion 216 represent the second 10 seconds (time period 2 280) of original data 212 in two different formats 250, 260.

Additionally, during this conversion process each portion 252, 254, 262, 264 of the data may be augmented. For example, information regarding closed captioning may be added to a portion of video data represented in the MPEG format, billing information may be added to a portion of a web page represented in HTML, or Java content may be added to a portion of the data to provide interactive controls to users of mobile device 180. These portions 252, 254, 262, 264 of data may also be optimized for delivery to a device 180 through the use of compression algorithms and the like.

After original data 212 is separated into portions 214, 216 and converted into different formats 250, 260, the resulting data portions 252, 254, 262, 264 may then be encapsulated in packets 256, 258, 266, 268 for delivery to device 180. Typical file formats for the encapsulation of data include layers dedicated to transmission protocols, application protocols, payload formats, and content formats. Ideally, the file format could also be used to deliver commands to the devices 180, 182, 184 which are to process, control, and render the data contained within those packets 256, 258, 266, 268.

In one embodiment, the encapsulation of the various portions of data 252, 254, 262, 264 uses a file format which allows the efficient encapsulation, transmission, reception, and decomposition of heterogeneous data. A packet 256, 258, 266, 268 may contain commands which have identical easy to decode structures, and which may be evaluated and executed in the order in which they are encoded, greatly simplifying the evaluation and execution of the commands and data contained within a packet 256, 258, 266, 268.

A more specific embodiment, which may encapsulate a 2500 byte image in .jpeg format, contains a command identifier, a payload length indicator, and a data payload. The command identifier may be a character with some mnemonic relation to the command's functionality, in this case an “i” for image decoding. The payload length indicator may be an ASCII encoded zero prefix number. For example, 002500 would indicate the payload of 2500 bytes. The data payload in this case would consist of the bytes actually composing the .jpeg image. When a device 180 receives a packet 256, 258, 266, 268 of this type, software running on the device 180 decodes the packet 256, 258, 266, 268 and sees the command identifier “i” coupled with a packet size of 2500 bytes, and knows the next 2500 bytes are a JPEG image and should be rendered as such.

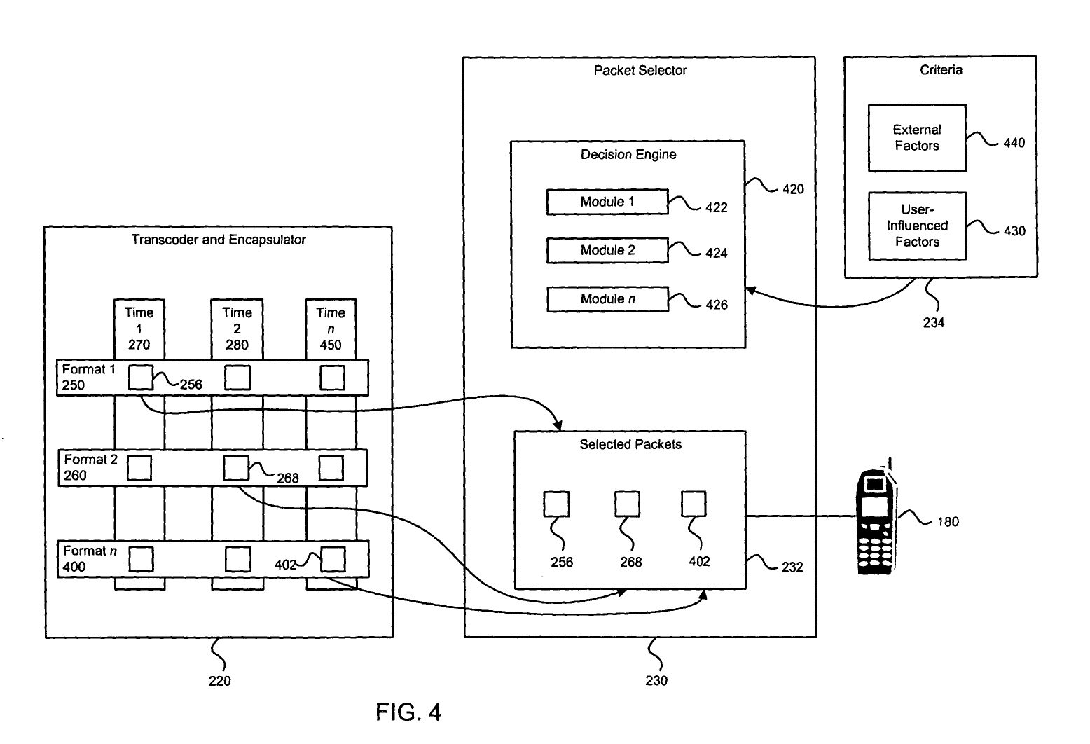

After the incoming data is digitized (STEP 210), converted to a variety of formats and encapsulated in packets (STEP 220), packets 232 may be selected for delivery to a device 180 based on a set of criteria 234 (STEP 230). This process is detailed in FIG. 4. A user of device 180 may wish to obtain certain content. That content may be digitized (STEP 210) and encapsulated into packets of varying formats (STEP 220). Packets 232 may then be selected to be delivered to device 180 based on a set of criteria (STEP 230).

This criteria 234 may include user influenced factors 430 such as bandwidth availability, the type of device 180, time of day, user account information or subscription service, and user age and preferences. Criteria 234 may also include external factors 440 such as the network configuration, the CPU and databases being utilized in the system and channel availability. Criteria 234 may be updated dynamically as packets 256, 268, 402 are selected to be delivered to device 180. Additionally, criteria 234 may be obtained directly from device 180, either via querying device 180 directly, or device 180 updating criteria 234 dynamically at the behest of a user. An extensive list of criteria 234 which may be used in the selection of packets 232, and means of obtaining and updating these criteria 234, will be obvious to those of ordinary skill in the art.

Based on criteria 234 packets 232 may be selected for delivery to device 180 (STEP 230). In many embodiments, decision engine 420 evaluates criteria 234 and based upon the confluence of criteria 234 extant at that moment, selects an appropriate packet 232 to deliver to device 180. In one of these embodiments, decision engine contains a module to evaluate each individual criterion. These modules 422, 424, 426, may use a set of rules to evaluate the appropriate packet to select based upon the criterion for which the module is responsible. Based upon the evaluations of individual modules 422, 424, 426 decision engine 420 can select an appropriate packet for device 180.

To continue with a more specific example, user of mobile telephone 180 wishes to watch television broadcast 140. Streaming content from television broadcast 140 is first digitized and encapsulated (STEPs 210, 220). After this, embodiments of the invention may begin selecting packets containing television broadcast 140 to be delivered to mobile telephone 180 (STEP 230).

Mobile telephone 180 may be a complex device on a high bandwidth connection with a subscription to a high bandwidth service. Criteria 234 indicate this, and based upon criteria 234 decision engine 420 selects a packet 256 containing the first portion (time period one 270) of the television broadcast 140 in high resolution MPEG format 250 to deliver to mobile telephone 180. Mobile telephone 180 receives, decodes and displays this packet 256, and sends an acknowledgement. Based upon the length of time it takes to receive the acknowledgement the current bandwidth of mobile telephone 180 may be reevaluated and criteria 234 updated.

Suppose that thereafter the wireless network 170 on which mobile telephone 180 resides experiences outages, and the acknowledgment of first packet 256 takes an unusually long time. The mobile telephone's 180 bandwidth may be recalculated, and the set of criteria 234 updated. During selection of the next packet to transmit to mobile telephone 180 decision engine 420 reevaluates criteria 234 and a packet 268 representing the second portion (time period two 280) of television broadcast 140 in a low resolution MPEG format 260 is accordingly selected. Mobile telephone 180 may then receive, decode, and display this packet. Although a viewer may notice a reduction in quality because second packet 268 encapsulates television broadcast 140 in a different format, none of broadcast 140 will have been dropped and the bandwidth required for transmission has been dynamically reduced to accommodate the current bandwidth capabilities of mobile telephone 180.

Suppose now that the user of mobile telephone 180 wishes to continue watching the same television broadcast 140 in another format, for example if he wishes to capture still images from broadcast 140. In this case, user of mobile telephone 180 may indicate he wishes to have the remainder of television broadcast 140 transmitted to mobile telephone 180 in a motion JPEG format. Media bridge 130 may receive this request and add it to criteria 234. During selection of the next packet to transmit to mobile telephone 180 decision engine 420 once again reevaluates criteria 234 and packet 402 representing the third portion (time period n 450) of television broadcast 140 in a low resolution motion JPEG format 400 is selected for delivery to mobile telephone 180. Again, although a viewer may notice a reduction in quality because third packet 402 encapsulates broadcast 140 in a different format, none of television broadcast 140 will have been dropped and the user's preferences will have been dynamically accommodated.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for packaging and distributing data to a device, comprising:
separating the data into one or more portions;
converting each portion into one or more formats;
encapsulating the converted data in one or more packets, each packet corresponding to one portion and one format; and
selecting a packet for delivery to the device based on a set of criteria.

2. The method of claim 1, further comprising digitizing the data.

3. The method of claim 2, further comprising storing the digitized data.

4. The method of claim 1, further comprising delivering the packet to the device.

5. The method of claim 4, wherein the device is operable to decode the packet.

6. The method of claim 5, wherein the packet contains decoding instructions.

7. The method of claim 1, wherein the set of criteria includes criteria received from the device, or determined from communication with the device.

8. The method of claim 1, further comprising updating the set of criteria.

9. The method of claim 8, wherein updating the criteria further comprises receiving a criterion from the device.

10. The method of claim 9, wherein updating the criteria further comprises analyzing a bandwidth of the device.

11. The method of claim 1, wherein converting the data further comprises augmenting the data.

12. The method of claim 11, wherein augmenting the data further comprises adding information including information pertaining to: vibration or a channel guide or e-commerce or games or additional video data or interactivity or preferences or surveys.

13. The method of claim 1, wherein selecting a packet further comprises evaluating the set of criteria.

14. The method of claim 13, wherein evaluating the set of criteria is based on a set of rules.

15. The method of claim 1, wherein the data to be packaged and distributed to the device is transmitted data, stored data, or data obtained from the Internet.

16. The method of claim 15, wherein the data is a television broadcast and the device is a mobile telephone on a wireless network.

17. A system for packaging and distributing data to a device, operable for:
separating the data into one or more portions;
converting each portion into one or more formats;
encapsulating the converted data in one or more packets, each packet corresponding to one portion and one format; and
selecting a packet for delivery to the device based on a set of criteria.

18. The system of claim 17, further operable for digitizing the data.

19. The system of claim 18, further operable for storing the digitized data.

20. The system of claim 17, further operable for delivering the packet to the device.

21. The system of claim 20, wherein the device is operable to decode the packet.

22. The system of claim 21, wherein the packet contains decoding instructions.

23. The system of claim 17, wherein the set of criteria includes criteria received from the device, or determined from communication with the device.

24. The system of claim 17, further operable for updating the set of criteria.

25. The system of claim 24, wherein updating the criteria further comprises receiving a criterion from the device.

26. The system of claim 25, wherein updating the criteria further comprises analyzing a bandwidth of the device.

27. The system of claim 17, wherein converting the data further comprises augmenting the data.

28. The system of claim 27, wherein augmenting the data further comprises adding information including information pertaining to: vibration or a channel guide or e-commerce or games or additional video data or interactivity or preferences or surveys.

29. The system of claim 17, wherein selecting a packet further comprises evaluating the set of criteria.

30. The system of claim 29, wherein evaluating the set of criteria is based on a set of rules.

31. The system of claim 17, wherein the data to be packaged and distributed to the device is transmitted data, stored data, or data obtained from the Internet.

32. The system of claim 31, wherein the data is a television broadcast and the device is a mobile telephone on a wireless network.

33. A system for packaging and distributing streaming data to devices on a wireless network, comprising:
a device on the wireless network; and
a media bridge, wherein the media bridge is coupled to the wireless network and a source of the streaming data, and wherein the media bridge is further configured for:
separating the streaming data into one or more portions;
converting each portion into one or more formats;
encapsulating the converted data in one or more packets, each packet corresponding to one portion and one format; and
selecting a packet for delivery to the device based on a set of criteria.

34. The system of claim 33, wherein the media bridge is further operable for digitizing the data.

35. The system of claim 34, wherein the media bridge is further operable for storing the digitized data.

36. The system of claim 33, wherein the media bridge is further operable for delivering the packet to the device.

37. The system of claim 36, wherein the device is operable to decode the packet.

38. The method of claim 33, wherein the packet contains decoding instructions.

39. The system of claim 33, wherein the set of criteria includes criteria received from the device, or determined from communication with the device.

40. The system of claim 33, wherein the media bridge is further operable for updating the set of criteria.

41. The system of claim 40, wherein updating the criteria further comprises receiving a criterion from the device.

42. The system of claim 41, wherein updating the criteria further comprises analyzing a bandwidth of the device.

43. The system of claim 33, wherein converting the data further comprises augmenting the data.

44. The system of claim 43, wherein augmenting the data further comprises adding information including information pertaining to: vibration or a channel guide or e-commerce or games or additional video data or interactivity or preferences or surveys.

45. The system of claim 33, wherein selecting a packet further comprises evaluating the set of criteria.

46. The system of claim 45, wherein evaluating the set of criteria is based on a set of rules.

47. The system of claim 33, wherein the data to be packaged and distributed to the device is transmitted data, stored data, or data obtained from the Internet.

48. The system of claim 47, wherein the source of the streaming data is a television broadcast and the device is a mobile telephone.

49. A software system or computer program for packaging and distributing data to a device, comprising a tangible storage medium containing instructions translatable for:
separating the data into one or more portions;
converting each portion into one or more formats;
encapsulating the converted data in one or more packets, each packet corresponding to one portion and one format; and
selecting a packet for delivery to the device based on a set of criteria.

50. The system or program of claim 49, further translatable for digitizing the data.

51. The system or program of claim 50, further translatable for storing the digitized data.

52. The system or program of claim 49, further translatable for delivering the packet to the device.

53. The system or program of claim 52, wherein the device is operable to decode the packet.

54. The system or program of claim 53, wherein the packet contains decoding instructions.

55. The system or program of claim 49, wherein the set of criteria includes criteria received from the device, or determined from communication with the device.

56. The system or program of claim 49, further translatable for updating the set of criteria.

57. The system or program of claim 56, wherein updating the criteria further comprises receiving a criterion from the device.

58. The system or program of claim 57, wherein updating the criteria further comprises analyzing a bandwidth of the device.

59. The system or program of claim 49, wherein converting the data further comprises augmenting the data.

60. The system or program of claim 59, wherein augmenting the data further comprises adding information including information pertaining to: vibration or a channel guide or e-commerce or games or additional video data or interactivity or preferences or surveys.

61. The system or program of claim 49, wherein selecting a packet further comprises evaluating the set of criteria.

62. The system or program of claim 61, wherein evaluating the set of criteria is based on a set of rules.

63. The system or program of claim 49, wherein the data to be packaged and distributed to the device is transmitted data, stored data, or data obtained from the Internet.

64. The system or program of claim 63, wherein the data is a television broadcast and the device is a mobile telephone on a wireless network.
